(19) United States
(12) Patent Application Publication
(10) Pub. No.: US 2004/0071168 A1
(43) Pub. Date: Apr. 15, 2004

(54) System and method for providing network timing recovery

(76) Inventor: Jason Bernard Etheridge Julyan, Bedfordshire (GB)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/614,374

(22) Filed: Jul. 8, 2003

Related U.S. Application Data
(60) Provisional application No. 60/393,755, filed on Jul. 8, 2002.

(51) Int. Cl. H04J 3/06

(52) U.S. Cl. 370/503

(57) ABSTRACT

A method and system for network timing recovery that recovers the timing reference by multiplying an 8 kHz reference clock up to one of a number of higher frequencies whilst maintaining phase alignment. Further, the present invention allows the 8 kHz reference signal to be generated from a software controlled frequency generator where no external reference is available. It also provides a configuration whereby the choice of external or internal 8 kHz reference is controlled by software, and further than said 8 kHz reference is always used as the input to the phase locked loop (PLL) clock multiplier. An algorithm to control the internal 8 kHz generator will not require to take into account “phase jumps” where the frequency suddenly changes by a large amount by passing the generated 8 kHz clock through the phase locked loop (PLL), where any large phase increase or decrease on the input clock will be filtered out and not passed though directly to the multiplied clock output.

### CROSS REFERENCE TO RELATED APPLICATIONS

Priority is claimed based on U.S. Provisional Application No. 60/393,755 entitled “System And Method For Providing Network Timing Recovery” filed Jul. 8, 2002.

### FIELD OF THE INVENTION

The present invention relates generally to the field of computer systems and, more particularly, to systems and methods for providing timing recovery in such computer systems.

### BACKGROUND OF THE INVENTION

In many types of data and voice networks such as xDSL, that employ fixed circuits to transport data, it is extremely important that a single timing source is referenced at each node in the network. Because over a period of time, a slight difference in system timing between nodes may result in buffer to overflow or underflow, where one of the devices on the network may transmit data in a slightly faster or slower manner than a receiving device would empty data from its buffer, therefore, in an ATM network, it is necessary it is necessary to ensure that the clocks at each end node are synchronized and locked to the same timing reference. Time compression multiplexing (TDM) is assumed as the end device, and that the timing reference for each TDM at the end of the network is obtained from a primary source outside the ATM network, and the timing reference is propagated across the network. The methods used to ensure that the timing source is carried accurately between nodes are, for example, adaptive clocking and synchronous residual time stamp (SRTS). In existing network timing recovery techniques such as synchronous residual time stamp (SRTS), the timing signal of a constant bit rate input service signal at the destination node of a synchronous ATM telecommunication network is recovered. At the source node, a free-running P-bit counter counts cycles in a common network clock. At the end of every RTS period formed by N service clock cycles, the current count of the P-bit counter, defined as the RTS, is transmitted in the ATM adaptation layer. Since the absolute number of network clock cycles likely to fall within an RTS period will fall within a range determined by N, the frequencies of the network and service clocks, and the tolerance of the service clock, P is chosen so that the 2.sup.P possible counts, rather than representing the absolute number of network clock cycles an RTS period, provide sufficient information for unambiguously representing the number of network clock cycles within that predetermined range. At the destination node, a pulse signal is derived in which the periods are determined by the number of network clock cycles represented by the received RTSs. This pulse signal is then multiplied in frequency by N to recover the source node service clock. In the event that a “phase jump” occurs, where the frequency suddenly changes by a large amount, the telecommunications equipments connected to the multiplied clock output may function incorrectly, if a large frequency is introduced on its clock inputs, thereby creating lack of synchronization between transmitter and receiver in a communication system.

### SUMMARY OF THE INVENTION

The present invention overcomes the problems noted above, and realizes additional advantages, by providing for methods and systems for network timing recovery. In particular, the present invention achieves such results by multiplying an 8 kHz reference clock up to one of a number of higher frequencies whilst maintaining phase alignment. Further, the present invention allows the 8 kHz reference signal to be generated from a software controlled frequency generator where no external reference is available.

In an additional embodiment, the present invention further provides a configuration whereby the choice of external or internal 8 kHz reference is controlled by software, and further than said 8 kHz reference is always used as the input to the PLL clock multiplier.

Software algorithms to control the internal 8 kHz generator do not need to take into account “phase jumps” where the frequency suddenly changes by a large amount, for instance from 7.9 kHz to 8.1 kHz. Legacy telecoms equipment connected to the multiplied clock output may well function incorrectly if a large step in frequency were to be introduced on its clock inputs. By passing the generated 8 kHz clock through the PLL any large phase jump on the input clock will be filtered out and not passed though directly to the multiplied clock output. This may enable more crude software algorithms to be implemented to control the internal clock generator—the advantage being less processing power would be required to implement said crude algorithms.

### BRIEF DESCRIPTION OF THE DRAWINGS

The present invention can be understood more completely by reading the following Detailed Description of the Preferred Embodiments, in conjunction with the accompanying drawings.

FIG. 1 is a simplified block diagram illustrating one embodiment of a network timing recovery device of the present invention.

FIG. 2 is simplified block diagram of a digital phase locked loop, according to an embodiment of the present invention.

FIG. 3 is flow chart, according to an embodiment of the present invention.

### DETAILED DESCRIPTION OF THE INVENTION

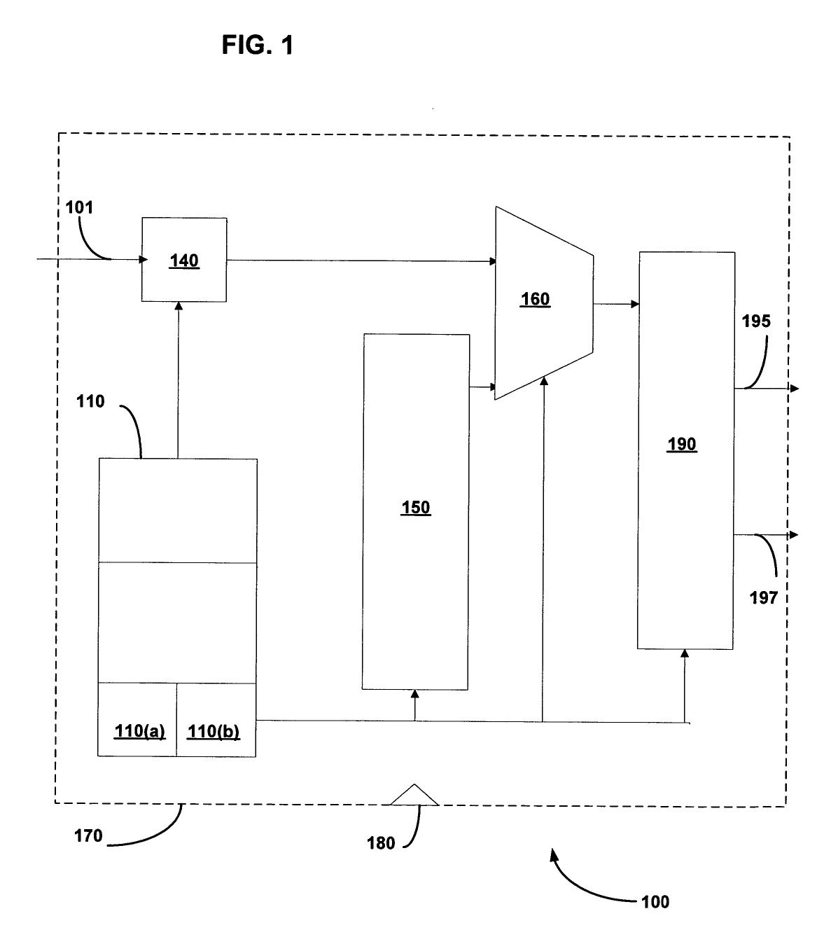

Referring now to FIG. 1, there is shown a simplified block diagram illustrating one embodiment of a network timing recovery (NTR) method and apparatus 100 configured in accordance with the present invention. The purpose of the NTR device is to generate a multiplied bit rate clock phase locked to an 8 kHz reference. The digital logic within the NTR implementation is clocked by a high speed bus clock, typically over 100 MHz. The method begins with the configuration and status registers 110, which are configured to allow the selection of various signal routing configurations and define various numerical constants. Status information allows a software to determine if a digital phase locked loop DPLL 190 has achieved frequency lock. A (1/N) divider 140 operating on an external clock reference input 101. The value of N of divider 140 is selected by the configuration register 110 to be either 1, 256, 193 or 192 depending on whether the external clock frequency 101 is an 8 kHz reference or a 2.048 MHz, 1.536 MHz or 1.544 MHz clock, respectively. The output of this divider is therefore always 8 kHz. A 16 bit (1/Y) divider circuit 150 is clocked with a high-speed bus 180, and where the value of Y is generated in a configuration register 110, and passed onto the (1/Y) divider; in applications where an external 8 kHz reference 101 is available which is the preferred operating mode, the DPLL 190 will be configured to phase lock to it, utilizing its limited bandwidth to reduce jitter on the output clock 195. However, in the more complex scenarios (adaptive clock recovery, synchronous residual timestamp, etc.) the burden is placed on the software to manipulate the (1/Y) divider to generate a reference clock of a desired rate (either above or below the nominal 8 kHz frequency) as deemed necessary to maintain synchronization with the far end equipment. The reference thus produced is sent to the DPLL 190, which filters out any jitter or non-continuities in its normal manner, thus, allowing very accurate specification of an 8 kHz reference or one slightly higher or lower for adaptive clock recovery. As an example, if the (1/Y) divider 150 is clocked with a high speed bus clock 180 running at 100 MHz then a value of Y=12500 gives an exact 8 kHz output.

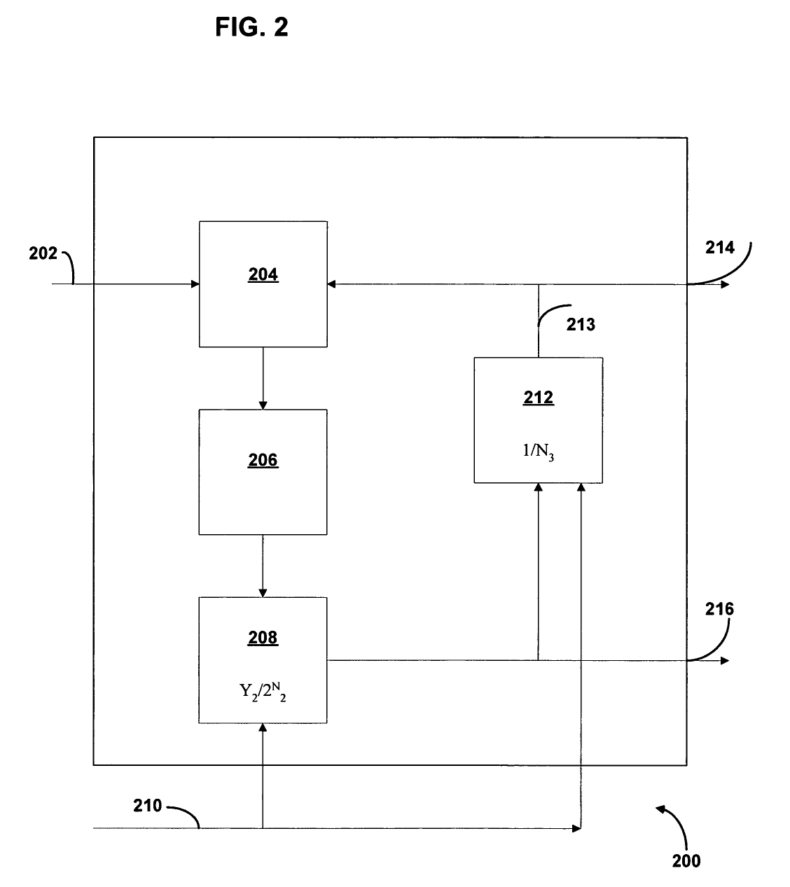

In another embodiment, and in reference to FIG. 2, a digital phase locked loop (DPLL) 200 comprises a numerically controlled oscillator (NCO) 208, implemented as a (Y/2N) divider that receives a high-speed bus clock 210. The values of N and Y are chosen such that the center frequency of the divider is either 2.048 MHz, 1.544 MHz or 1.536 MHz (which are key telecoms standard bit rate clock frequencies). In a preferred implementation the value of N has been fixed for all frequencies to simplify the arithmetic logic, and the value of Y is modified by the digital logic to produce the phase locking behavior of the DPLL. The greater the number of bits used to represent N and Y the better the accuracy of the centre frequency will be (but the digital arithmetic logic becomes increasingly complex and hence slower). The output of the numerically controlled oscillator (NCO) 208 is divided down with a (1/N) divider 212 to produce an 8 kHz output reference 213. The value of N in the (1/N) divider 212 may be either 256, 193 or 192 depending on whether the numerically controlled oscillator (NCO) 208 clock output is 2.048 MHz, 1.544 MHz or 1.536 MHz respectively. The output of the (1/N) divider 212 is fed into a phase comparator 204 that compares a time delay between rising edges on this output reference signal 213 and an 8 kHz input reference signal 202 to determine the sign and magnitude of any phase error between the two. The phase error is then passed onto a low pass filter 206 to low pass filtered (i.e. divided by some constant value) and the result is fed into the numerically controlled oscillator (NCO) 208 as a correction factor to be used for the modification of its Y value. In more detailed scenario, if the 8 kHz reference edge occurs before the 8 kHz numerically controlled oscillator (NCO) 208 edge then the numerically controlled oscillator (NCO) 208 frequency is determined to be too low so the numerically controlled oscillator (NCO) 208 Y value is decreased by an amount proportional to the delta time between the two edges. Similarly, if the 8 kHz reference edge occurs after the 8 kHz numerically controlled oscillator (NCO) 208 edge then the numerically controlled oscillator (NCO) 208 frequency is determined to be too high and the numerically controlled oscillator (NCO) 208 Y value is reduced. The digital phase locked loop DPLL 200 is deemed to be “locked” to the reference when the magnitude of the phase error is small.

In applications where an external 8 kHz reference is available, the DPLL will be configured to phase lock to it, utilizing its limited bandwidth to reduce jitter on the output clock. This is the preferred operating mode. However, in the more complex scenarios (adaptive clock recovery, synchronous residual timestamp, etc.) the burden is placed on software to manipulate the (1/Y) divider to generate a reference clock of a desired rate (either above or below the nominal 8 kHz frequency) as deemed necessary to maintain synchronization with the far end equipment. The reference thus produced is sent to the DPLL which will filter out any jitter or non-continuities in its normal manner. Using this arrangement has the advantage of guaranteeing that the multiplied clock output produced under software control will be constrained within the design parameters of standard telecommunications equipment.

One further capability that arises from this network timing recovery (NTR) method, is that it can be configured to take one frequency of multiplied reference as an input and generate a different (yet phase locked) multiplied output. For example, an output clock of 2.048 MHz (telecommunications standard “T1” bit rate) can be generated from an external input clock of 1.544 MHz (telecommunications standard “E1” bit rate) and vice versa.

In systems where an external 8 kHz network timing reference (NTR) is available, the simple requirement for the NTR block is to remove jitter and then regenerate this signal, together with a phase-locked clock at one of 2.048 MHz, 1.536 MHz or 1.544 MHz, depending on whether the application is E1 or T1.

Some TDM interface modes of operation may require higher frequencies than the standard 2.048 MHz, such as 16.384 MHz, 8.192 MHz and 4.096 MHz. The NTR block described above does not generate these clocks, and such applications will require an external clock synchronizer/generator. In these applications the NTR reference input to the NTR block will actually be the multiplied phase locked clock, so configuration options are also provided to bypass the NTR block altogether, or to divide this clock down to an 8 KHz reference. The TDM block will generate the necessary select signals to achieve the required routing of its clock signals.

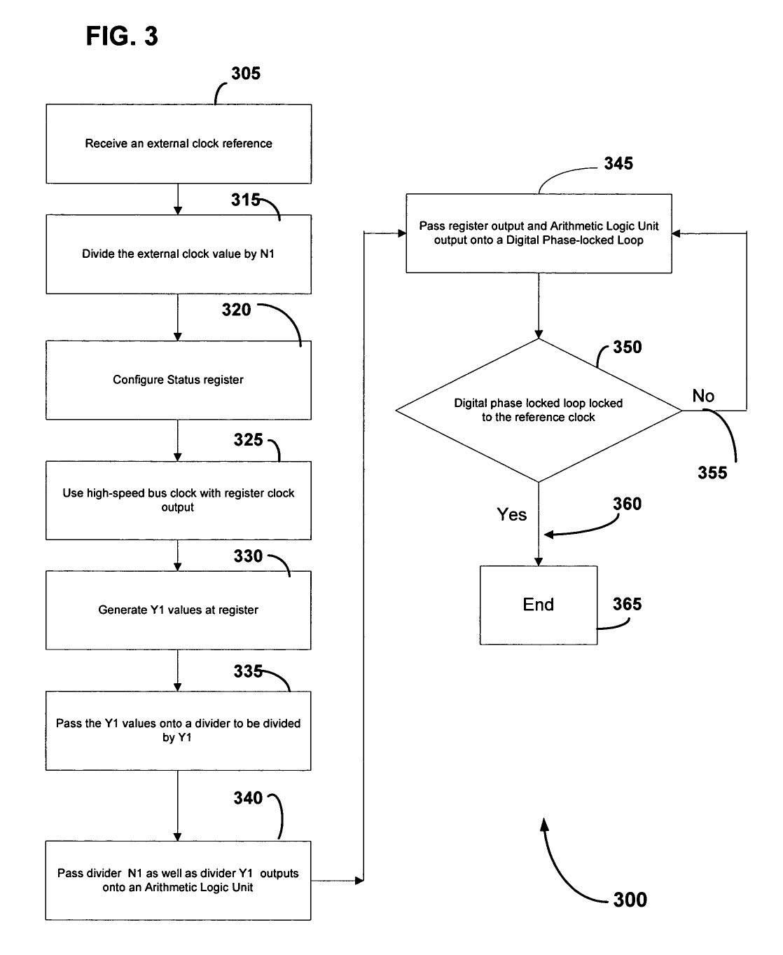

In another embodiment of the present invention, and in reference to FIG. 3, The method begins with receiving an external clock reference in step 305, the external clock value is divided by an integer N in step 315, in step 320, a status register is configured to allow the selection of various signal routing configurations and define various numerical constants. The status register clock employs a high-speed bus clock, and it generates a Y value in steps 325 and 330 respectively, the generated Y value is passed onto 16 bit (1/Y) divider circuit in step 335, the outputs of the N-divider as well as the Y-divider are passed onto a an arithmetic logic unit in step 340, which in turn calculates a the external clock signal and passes it onto a digital phase-locked loop in step 345, which compares the a locally generated output reference signal to the input reference signal from the arithmetic logic unit in step 350. When the digital phase-locked loop locks on to the reference signal, the output is the desired result, otherwise the process goes back to step 345, until the desired result is achieved.

As already noted, the PLL structure is used to multiply the 8 kHz clock up to 2.048 MHz. Ideally, the PLL requires a fast acquisition time and very low bandwidth (good jitter filtering) simultaneously. These are conflicting requirements as low bandwidth PLLs take a very long time to achieve lock. To allow the user to avoid this problem the PLL is provided with a fast acquisition mode, (enabled by setting the PLL_HIGHGEAR flag in the NTR_CS register; see Table 8-59) which doubles the PLL bandwidth, at the expense of greater jitter.

ADSL supports the distribution of a timing reference over the network using an 8 kHz timing marker as an NTR. ATU-C generates an 8 kHz local timing reference (LTR) by dividing its sampling clock by the appropriate integer (276 for the standard 2.208 MHz ADSL sampling clock). It then transmits the change in phase offset between the input NTR and LTR (measured in cycles of the 2.208 MHz clock, that is, units of approximately 452 ns) from the previous superframe to the present one. This is encoded into four bits (ntr[3:0]), representing a signed integer in the range −8 to +7 in 2 s-complement notation, with positive values indicating that the LTR is higher in frequency than the NTR.

The NTR has a maximum frequency variation of ±32 parts per million ppm (ANSI T1.101) and the ADSL LTR has a maximum frequency variation of ±50 ppm. The maximum mismatch is therefore ±82 ppm. This can result in an average change of phase offset of approximately ±3.5 clock cycles over one 17 ms superframe, which can be mapped into the four overhead bits.

The largest phase offset to be corrected is:

|(−8*452 ns)|=3616 ns per 17 ms.

Normalizing this to the 2.048 MHz clock being generated gives a correction factor of 0.10386 ns per 2.048 MHz (488.28125 ns) clock cycle. The smallest phase offset to be corrected is 452 ns per 17 ms or 0.01298 ns per 2.048 MHz clock cycle

In yet another embodiment of the present invention, and in reference to FIG. 1, The network timing recovery (NTR) method and apparatus 100, contains two registers 110a and 110b to control its operation. The NTR_CSR (Control and Status Register) is split notionally into a 16-bit control register (bits 15:0) and a 16-bit status register (bits 31:16), though not all these bits are actually used. The registers are summarized in Table 8-57:

TABLE 8-57
NTR registers

| Address | Name | Description |
|---|---|---|
| 0 × 3000.0014 | NTR_XYDIV | Network timing reference X:Y divider |
| | | register. |
| 0 × 3000.0018 | NTR_CS | Network timing reference control/status |
| | | register. |

The NTR XY div register (CS_NTR_XYDIV)

TABLE 8-58
NTR XY div register (CS_NTR_XYDIV)
Register: CS_NTR_XYDIV Address: 0 × 3000.0014

| Bits | Name | Mode | Reset | Description |
|---|---|---|---|---|
| 31:15 | Reserved | | | |
| 14:0 | YVAL | R/W | 0 | NTR: Y value; i.e. divisor for 1/Y |
| | | | | divider. |

full name: CF_PERIPH_CS_NTR_XYDIV
YVAL: The Y value to use for the NTR 1/Y divider.

To generate an 8 KHz signal the required value is:

| | |
|---|---|
| At 166 MHz: | 0 × 5161 |
| At 133 MHz: | 0 × 411A |

Writing a value of 0 will stop the divider.

The NTR Control and Status register (CS_NTR_CS)

TABLE 8-59
NTR Control and Status register (CS_NTR_CS)
Register: CS_NTR_CS Address: 0 × 3000.0018

| Bits | Name | Mode | Reset | Description |
|---|---|---|---|---|
| 31:19 | Reserved | | | |
| 18 | SYSCLK_MODE | RO | 0 | System clock mode; 166 MHz |
| | | | | (clear) or ‘other’ (set). |
| 17 | NTR_IMPAIRED | RO | 0 | Asserted if no edges detected |
| | | | | on 8 kHz reference clock |
| | | | | input. |
| 16 | PLL_LOCKED | RO | 0 | Asserted when the PLL is ‘in |
| | | | | lock’ with the 8 kHz ref. |
| | | | | clock input. |
| 15:6 | Reserved | | | |
| 5:4 | NTR_CLKDIV | R/W | 0 | Selects divider value for in- |
| | | | | coming reference clock signal. |
| 3 | PLL_HIGHGEAR | R/W | 0 | Set to increase bandwidth to |
| | | | | give greater pull-in range. |
| 2 | PLL_REFSRC | R/W | 0 | Select reference source for 8 |
| | | | | kHz reference clock; set for |
| | | | | ‘internal’. |
| 1:0 | NTR_MULTSEL | R/W | 0 | Select multiplier for TDM bit |
| | | | | clock. |

Full name: CF_PERIPH_CS_NTR_CS

YVAL: Indicates the mode in which Sysclock is operating; the possible values are:

0: 166 MHz

1: ‘Other’—taken to mean 133 MHz.

NTR_IMPAIRED: When set, this flag indicates that no clock edges are being detected on the 8 kHz input reference signal. The PLL will continue to generate a clock signal, in free-run mode, when the input reference is impaired.

PLL_LOCKED: When set, this flag indicates that the PLL has achieved lock with the 8 kHz reference source. This flag tracks the lock between the PLL and the reference source, and will be clear if lock has been lost. The value of this flag has no meaning if NTR_IMPAIRED is set.

NTR_CLKDIV: This field determine the preset divide ratio which is to be applied to the incoming NTR_CLK_IN signal to generate the 8 kHz network timing reference signal. The default setting of 0 divides the clock by 1, for an incoming 8 kHz external reference setting. The allowed values and their significance are shown in Table 8-60:

TABLE 8-60
NTR_CLKDLV field values

| NTR_CLKDIV | × by | For NTR_CLK_IN frequency: |
|---|---|---|
| 00 | 1 | 8 kHz |
| 01 | 256 | 2.048 MHz |
| 10 | 193 | 1.536 MHz |
| 11 | 192 | 1.544 MHz |

PLL_HIGHGEAR: When set, this flag increases the PLL bandwidth and so increases its pull-in range. This will result in decreased jitter filtering, but will allow a poorer reference signal to be tracked.

PLL_REFSRC: This flag determines whether the 8 kHz reference source is taken from the incoming external NTR_CLK_IN signal or from the internal 1/Y divider. Its possible values are:

0: Use NTR_CLK_IN signal;

1: Use internal 1/Y divider.

NTR_MULTSEL: This field selects the preset multiplier to use to generate the TDM bit clock. Its allowed their significance are shown in Table 8-61:

TABLE 8-61
NTR_MULTSEL field values

| NTR_MULTSEL | × by | For TDM clock frequency: |
|---|---|---|
| 00 | 256 | 2.048 MHz |
| 01 | 193 | 1.544 MHz |
| 10 | 192 | 1.538 MHz |

| | |
|---|---|
| 11 | Reserved |

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

We claim:

1. A method of recovering a network timing clock of a service input of a packet-based telecommunications network, comprising the steps of:
receiving an external clock reference from a source node as an input;
providing an external clock with a frequency reference value;
dividing the external clock reference input by an integer;
configuring a status register depending on the value of the external clock frequency;
generating an integer value at the status register;
providing a divider for the generated value of the status register;
providing a digital phase locked loop to lock onto the external reference clock

2. The method of claim 1, wherein the integer that divides the external clock value is N.

3. The method of claim 1, wherein the integer value generated at the status register is Y.

4. The method of claim 1, wherein digital phase locked loop compares the external reference clock and a locally generated reference clock to produce an output reference clock.

5. The method of claim 1, wherein a numerically controlled oscillator is used to generate the local reference clock.

6. An apparatus for recovering a network timing clock of a service input of a packetbased telecommunications network, comprising the steps of:
a receiver for receiving an external clock reference from a source node as an input;
a divider for dividing the external clock reference input by an integer;
a status register to be configured depending on the value of the external clock frequency;
a generator that generates an integer value at the status register;
a divider for dividing the generated value of the status register;
a digital phase locked loop that locks onto the external reference clock

7. The apparatus of claim 6, wherein the integer that divides the external clock value is N.

8. The apparatus of claim 6, wherein the integer value generated at the status register is Y.

9. The apparatus of claim 6, wherein digital phase locked loop compares the external reference clock and a locally generated reference clock to produce an output reference clock.

10. The apparatus of claim 6, wherein a numerically controlled oscillator is used to generate the local reference clock.
